(19) United States
(12) Patent Application Publication
(10) Pub. No.: US 2024/0283330 A1
(43) Pub. Date: Aug. 22, 2024

(54) MAGNETIC GENERATOR

(71) Applicant: Arron Pacheco, HONOLULU, HI (US)

(72) Inventor: Arron Pacheco, HONOLULU, HI (US)

(21) Appl. No.: 18/222,609

(22) Filed: Jul. 17, 2023

Related U.S. Application Data
(63) Continuation-in-part of application No. 18/111,666, filed on Feb. 20, 2023, now abandoned.

(51) Int. Cl. H02K 11/00; H02K 1/14; H02K 3/18

(52) U.S. Cl. CPC H02K 11/0094; H02K 1/14; H02K 3/18

(57) ABSTRACT

The present invention relates to a magnetic generator that includes an armature having an attachment device, a pair of LED lights, a magnetized rotating assembly and a pair of LED casings. The attachment device is adapted to hang the armature at a specific location, where the armature alters a pair of magnetic fields above and below the magnetic powered to generate electrical power. The pair of LED lights are powered by the pair of magnetic fields from the magnetized rotating assembly, the magnetized rotating assembly includes a plurality of wings and a plurality of magnets, wherein each of the wings have a first end that each of the magnets are attached to.

### CROSS REFERENCE TO OTHER APPLICATIONS

This application is a continuation in part to U.S. patent application Ser. No. 18/111,666 filed on Feb. 20, 2023.

### BACKGROUND OF THE INVENTION

### Field of the Invention

The present invention is a generator. More specifically, the present invention is a magnetic generator.

### Description of the Related Art

Electricity may be produced through hydropower, burning of coal, fossil fuels, wind turbines, and nuclear power plants. Wind turbines generate electricity in an environmentally friendly way, while the others contribute to global warming and natural resource depletion.

Although solar technology is gaining popularity rapidly, there is a need for finding green ways to generate electricity for powering small devices.

### SUMMARY OF THE INVENTION

The present invention is a generator. More specifically, the present invention is a magnetic generator.

The magnetic generator includes an armature having an attachment device, a pair of LED lights, a magnetized rotating assembly assembly and a pair of LED casings, the attachment device adapted to hang the armature at a specific location, the armature adapted to alter a pair of magnetic fields above and below the magnetized rotating assembly assembly to generate electrical power, the pair of LED lights adapted to be powered by the pair of magnetic fields from the magnetized rotating assembly, the magnetized rotating assembly includes a plurality of wings and a plurality of magnets, wherein each of the wings have a first end that each of the magnets are attached to, the pair of LED casings contain each of the pair of magnetic fields above and below the magnetized rotating assembly, a magnetic system having a casing, a plurality of copper spools, one or more stator magnets formed underneath the casing and one or more brushes and terminals positioned below the one or more stator magnets, the magnetic system adapted to receive the electromagnetic energy from the armature adapted to generate electrical energy adapted to illuminate the pair of LED lights and a plurality of armature extensions adapted to extend downward from the magnet system to contain one or more stacked output generators.

It is an object of the present invention to provide a magnetic generator that creates electricity from a renewable source using magnets, which may be stored in small and big batteries.

It is an object of the present invention to provide a magnetic generator that creates electricity through a simple system of magnets with the help of the wind, to in-turn power a range of novelty toys to light emitting diode or LED lighting products and gadgets.

It is an object of the present invention to provide a magnetic generator that is designed to work with very little friction and may potentially change the way consumers preserve earth energy.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a magnetic generator, in accordance with one embodiment of the present invention.

FIG. 2 illustrates a side view of a first magnet, in accordance with one embodiment of the present invention.

FIG. 3 illustrates a side view of a first magnetic system, in accordance with one embodiment of the present invention.

FIG. 4 illustrates a side view of a second magnetic generator, in accordance with one embodiment of the present invention.

FIG. 5 illustrates a side view of a second magnet, in accordance with one embodiment of the present invention.

FIG. 6 illustrates a side view of a second magnetic system, in accordance with one embodiment of the present invention.

FIG. 7 illustrates a side view of a third magnetic generator, in accordance with one embodiment of the present invention.

FIG. 8 illustrates a side view of a third magnetic system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. These operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

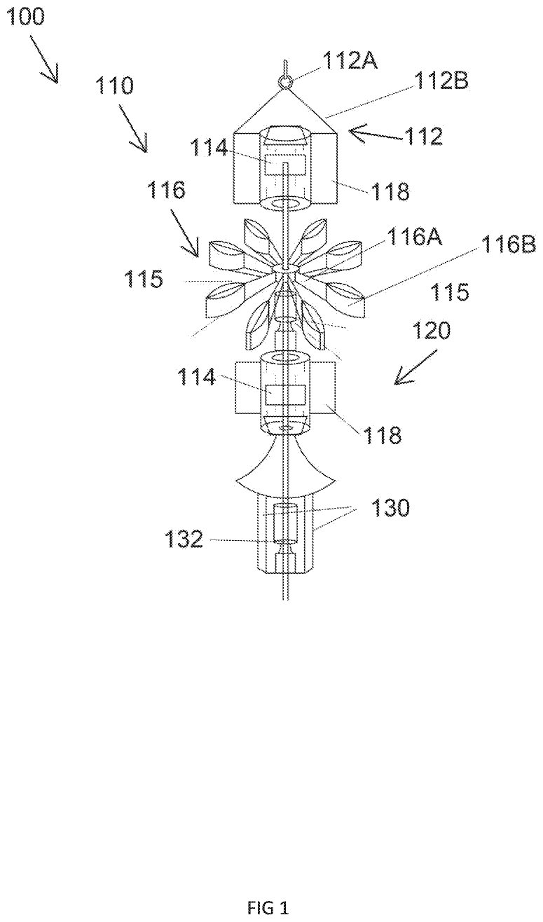

FIG. 1 illustrates a side view of a first magnetic generator 100, in accordance with one embodiment of the present invention.

The magnetic generator 100 may include an armature 110, a first magnetic system 120 and a plurality of armature extensions 130.

The armature 110 may include an attachment device 112, a pair of LED lights 114, a magnetized rotating assembly 116 and a pair of LED casings 118. The attachment device 112 may be adapted to hang the armature 110 at a specific location from a hanging device such as a hook (both not shown) or other suitable hanging device. Thea attachment device 112 may include one or more rings 112A and/or one or more lines 112B adapted to receive the hanging device. The armature 110 may be adapted to alter a pair of magnetic fields 115 above and below the magnetized rotating assembly 116 to generate electrical power. The pair of LED lights 114 may adapted to be powered by the pair of magnetic fields 115 from the magnetized rotating assembly 116. The magnetized rotating assembly 116 may include a plurality of wings 116A and a plurality of magnets 116B. Each of the wings 116A may have a first end 116A′ that the each of the magnets 116B are attached to. The pair of LED casings 118 may contain each of the pair of magnetic fields 115 above and below the magnetized rotating assembly 116. The first magnetic system 120 may be adapted to receive the electromagnetic energy from the armature 110 to generate electrical energy adapted to illuminate the pair of LED lights 114. The armature extensions 130 may extend downward from the first magnet system 120 to contain one or more stacked output generators 132.

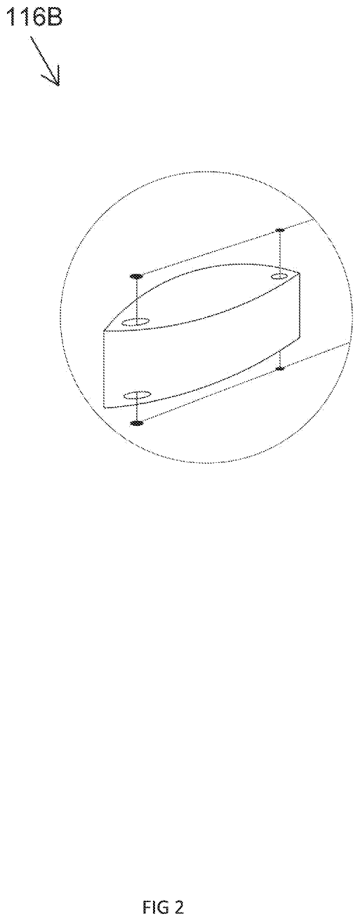

FIG. 2 illustrates a side view of a first magnet (FIG. 1, 116B), in accordance with one embodiment of the present invention.

The magnets 116B may be adapted to either attract or repel other magnets (not shown) adjacent to the magnetized rotating assembly (FIG. 1, 116) to propel the magnetized rotating assembly 116 adapted to generate power to illuminate the pair of LED lights (FIG. 1, 114). Typically, the pair of LED lights 114 does not require as much relative energy as illuminating other types of lights such as incandescent lights, fluorescent lights, Halogen lights and other suitable lights. The magnets 116B may be made of neodymium to provide strength and durability to the magnets 116B.

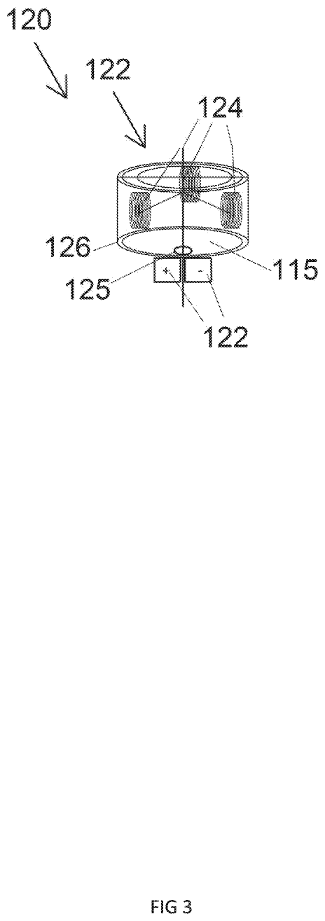

FIG. 3 illustrates a side view of a second magnetic system (FIG. 1, 120), in accordance with one embodiment of the present invention.

The first magnet system 120 may include a casing 122, a plurality of copper spools 124, one or more stator magnets 126 formed underneath the casing 122 and one or more brushes and terminals 128 positioned below the one or more stator magnets 126. A donut magnet 125 may be formed underneath the bottom magnetic field 115 from the armature (FIG. 1, 110), the first magnet system 120 and the bottom magnetic field 115.

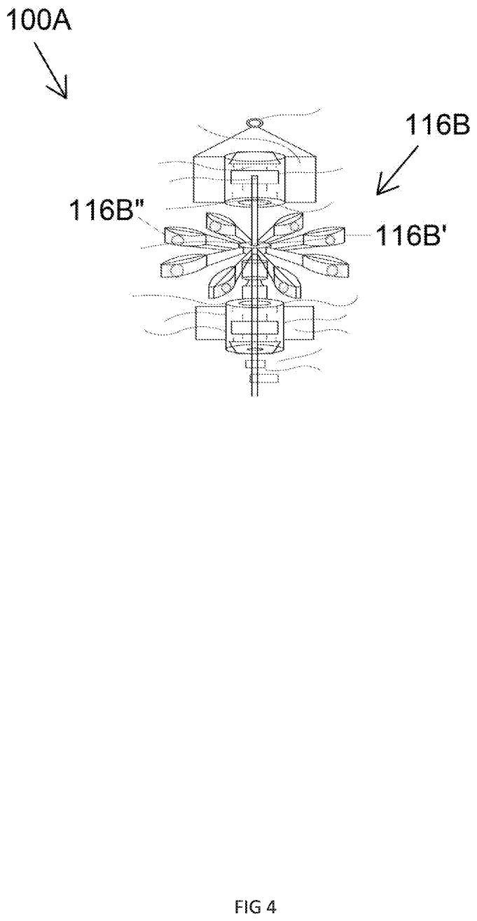

FIG. 4 illustrates a side view of a second magnetic generator 100A, in accordance with one embodiment of the present invention.

The magnets 116B may be a plurality of alternating n-magnets 116B′ and a plurality of alternating s-magnets 116B″. The n-magnets 116B′ may have a North polarity or negative charge and the s-magnets 116B″ may have a South polarity or positive charge.

The second magnetic generator 100A may be adapted to vertically stack the one or more stacked output generators (FIG. 1, 132) many times over. If the electromagnetic pattern from the magnetized rotating assembly (FIG. 1, 116) is correct, the second magnetic generator 100A may be adapted to rotate.

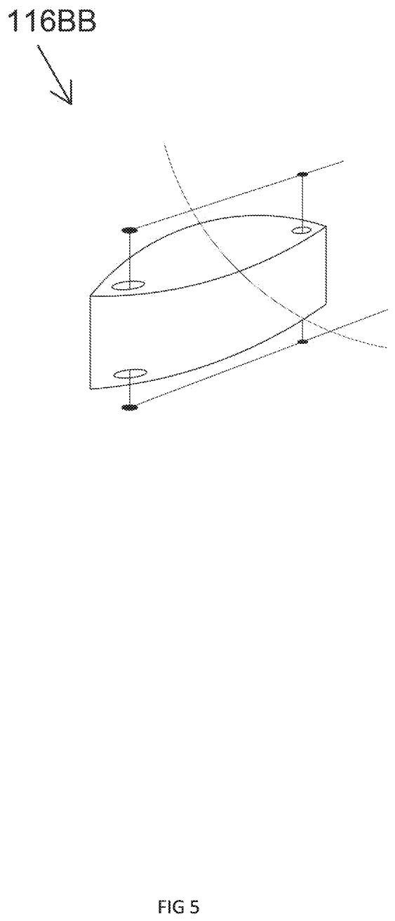

FIG. 5 illustrates a side view of a second magnet 116B8, in accordance with one embodiment of the present invention.

The second magnets 116B8 are illustrated in FIG. 4 that illustrates an arrangement of the alternating n-magnets 116B′ and the alternating s-magnets 116B″ that is adapted to positively rotate the second magnetic generator 100A.

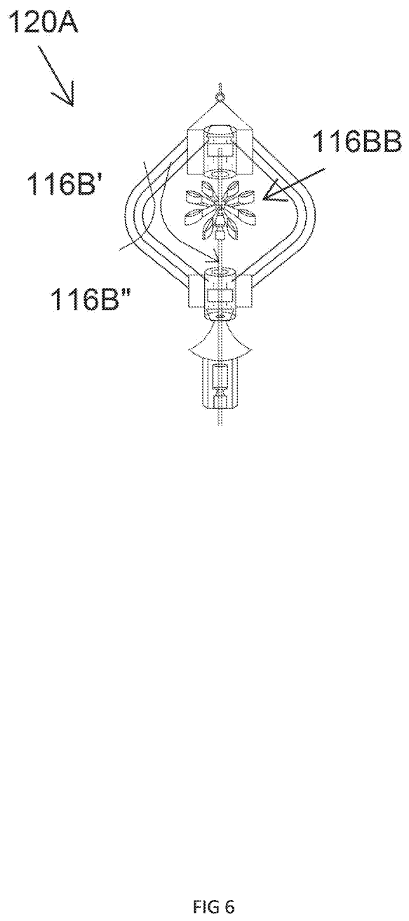

FIG. 6 illustrates a side view of a second magnet system 120A, in accordance with one embodiment of the present invention.

The second magnet system 120A may be the second magnets 116B8 that are adapted to produce wingless magnetic gearing. The second magnets 116B8 may be an arrangement of the alternating n-magnets 116B′ and the alternating s-magnets 116B″ that may be adapted to reverse rotate the second magnetic generator 100A.

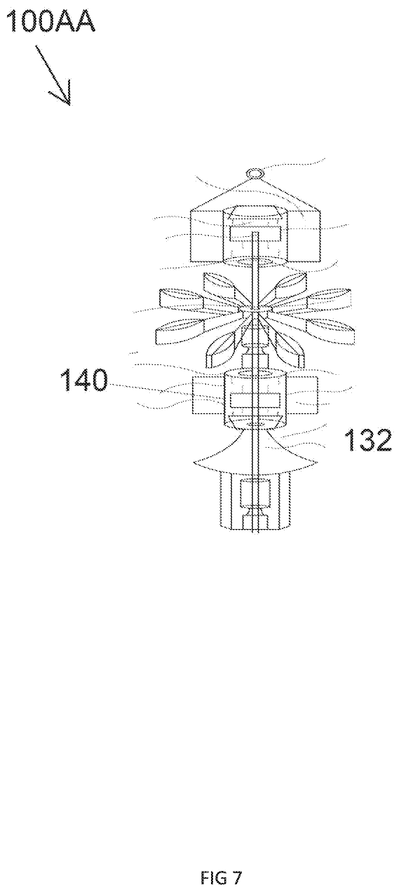

FIG. 7 illustrates a side view of a third magnetic generator 100AA, in accordance with one embodiment of the present invention.

The third magnetic generator 100AA may include a plurality of longer armature extensions 140. The longer armature extensions 140 are relatively longer than the armature extensions 130 described in FIG. 1 that may allow for more one or more stacked output generators 132 than the armature extensions 130 described in FIG. 1.

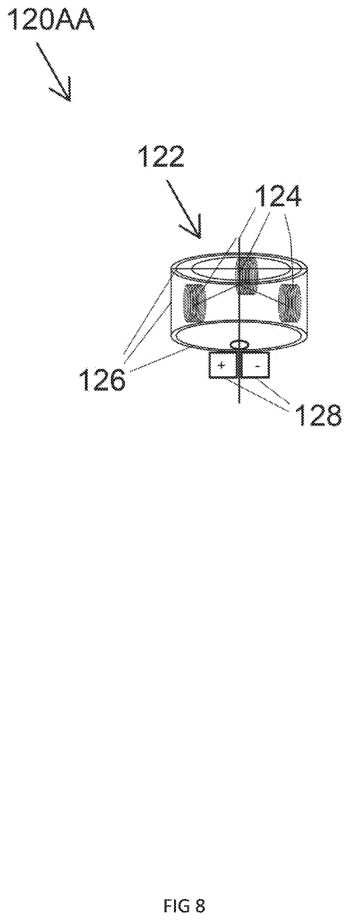

FIG. 8 illustrates a side view of a third magnet system 120AA, in accordance with one embodiment of the present invention.

The third magnet system 120AA may include the one or more stator magnets 126 that surround the bottom, the top and the sides of the casing 122 that are adapted to increase generated electrical energy. The copper spools 124 may be mounted on the armature (FIG. 1, 110) of the wings (FIG. 1, 116A) of the magnetized rotating assembly (FIG. 1,116).

The magnetic generators are adapted to work on the principle of a series of floating magnets spinning due to airflow and/or pressure of the wind. The magnetic generators are adapted to generate electricity just like in wind turbines, but at a smaller scale. This electrical output is adapted to be stored into a medium first, which may then be adapted to converted into direct current or DC, resulting in wind-generated and green energy. The magnetic generators may greatly contribute to saving and sustaining the environment and natural resources.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A magnetic generator, comprising:
an armature having an attachment device, a pair of LED lights, a magnetized rotating assembly and a pair of LED casings, the attachment device adapted to hang the armature at a specific location, the armature adapted to alter a pair of magnetic fields above and below the magnetized rotating assembly to generate electrical power, the pair of LED lights adapted to be powered by the pair of magnetic fields from the magnetized rotating assembly, the magnetized rotating assembly includes a plurality of wings and a plurality of magnets, wherein each of the wings includes a first end with a magnet attached thereto, the pair of LED casings contain each of the pair of magnetic fields above and below the magnetized rotating assembly;
a magnetic system having a casing, a plurality of copper spools, one or more stator magnets formed underneath the casing and one or more brushes and terminals positioned below the one or more stator magnets, the magnetic system adapted to receive the electromagnetic energy from the armature adapted to generate electrical energy adapted to illuminate the pair of LED lights; and
a plurality of armature extensions adapted to extend downward from the magnet system to contain one or more stacked output generators.

2. The magnetic generator according to claim 1, further comprising a donut magnet formed underneath the bottom magnetic field from the armature, the magnet system and the bottom magnetic field.

3. The magnetic generator according to claim 1, wherein the magnets adapted to propel the magnetized rotating assembly to generate power adapted to illuminate the pair of LED lights.

4. The magnetic generator according to claim 3, wherein the magnets are made of neodymium to provide strength and durability to the magnets.

5. The magnetic generator according to claim 1, wherein the magnets are a plurality of alternating n-magnets and a plurality of alternating s-magnets.

6. The magnetic generator according to claim 1, wherein the alternating n-magnets and the alternating s-magnets are adapted to positively rotate the magnetized rotating assembly.

7. The magnetic generator according to claim 1, wherein the alternating n-magnets and the alternating s-magnets are adapted to reverse rotate the magnetized rotating assembly.

8. The magnetic generator according to claim 1, wherein an electromagnetic pattern from the magnetized rotating assembly is correct, the magnetized rotating assembly is adapted to rotate.

9. The magnetic generator according to claim 1, wherein the one or more stator magnets formed underneath the casing.

10. The magnetic generator according to claim 1, wherein the one or more stator magnets surround a bottom, a top and sides of the casing.

11. The magnetic generator according to claim 1, wherein the magnet system includes a plurality of wingless magnets adapted to produce magnetic gearing.
